(19) United States
(12) Patent Application Publication
(10) Pub. No.: US 2018/0118597 A1
(43) Pub. Date: May 3, 2018

(54) PORTABLE OUTDOOR WATER PURIFIER

(71) Applicant: B9, PLASTICS, INC., ONTARIO County, NY (US)

(72) Inventor: Robert BECHTOLD, Ontario County, NY (US)

(21) Appl. No.: 15/353,035

(22) Filed: Nov. 16, 2016

(30) Foreign Application Priority Data
Oct. 31, 2016 (CN) 201610931136.3

(51) Int. Cl. C02F 9/00; C02F 1/00; C02F 1/28; C02F 1/32; B01D 39/10

(52) U.S. Cl. CPC C02F 9/00; C02F 1/002; C02F 1/008; C02F 1/283; B01D 2239/0442; B01D 39/10; C02F 2201/002; C02F 2303/04; C02F 1/325

(57) ABSTRACT

A portable outdoor water purifier includes a water absorption base, a filter element assembly, an electronic control assembly, and a filter container. The filter element assembly is installed in the filter container. The water absorption base is mounted to a lower end of the filter container. The water absorption base is connected with the filter element assembly. The electronic control assembly is mounted to an upper end of the filter container. The electronic control assembly includes a water outlet seat. Through the water absorption base and the filter element assembly, outdoor water can be filtered and sterilized layer by layer for a user to quickly get a large number of virus-free, bacteria-free, pollution-free safe drinking water in the wild, with high safety factor. This is an effective solution to the demand of drinking water for the outdoor sports enthusiasts.

### FIELD OF THE INVENTION

The present invention relates to a water purifier, and more particularly to a portable outdoor water purifier.

### BACKGROUND OF THE INVENTION

A water purifier is a small-sized water treatment apparatus capable of performing deep purification treatment for better water quality in accordance with the requirements of use. The use of a water purifier can effectively help people to get clean water, which is beneficial for health. It is inconvenient to carry a water purifier for domestic use to the outdoors. With an increase of outdoor activities and the more pollution of water resources in the wild, the use and carrying of the traditional water purifier is facing many problems.

In general, the existing portable outdoor water purifiers on the market are a suction pipe structure which is small in size and easy to carry. But, the water output is small, the sterilization effect is not good, and the service life of the filter element is short. Accordingly, the inventor of the present invention has devoted himself based on his many years of practical experiences to solve these problems.

### SUMMARY OF THE INVENTION

The primary object of the present invention is to overcome the shortcomings of the prior art and to provide a portable outdoor water purifier for the user to quickly get a large number of virus-free, bacteria-free, pollution-free safe drinking water.

In order to achieve the aforesaid object, the portable outdoor water purifier of the present invention comprises a water absorption base, a filter element assembly, an electronic control assembly, and a filter container. The filter element assembly is installed in the filter container. The water absorption base is mounted to a lower end of the filter container. The water absorption base is connected with the filter element assembly. The electronic control assembly is mounted to an upper end of the filter container. The electronic control assembly comprises a water outlet seat.

Preferably, an inner chamber of the water absorption base is provided with a first filtration layer. The filter element assembly is provided with a second filtration layer and a sterilization layer. A water outlet of the water absorption base is communicated with a water absorption passage of the filter element assembly. An outlet of the water absorption passage of the filter element assembly is communicated with the water outlet seat of the electronic control assembly.

Preferably, the first filtration layer comprises a plastic mesh, a stainless steel mesh, and a nonwoven fabric mesh. The second filtration layer comprises a carbon filter cartridge. The sterilization layer comprises an ultraviolet lamp. The ultraviolet lamp is located in an inner chamber of the carbon filter cartridge. The ultraviolet lamp is electrically connected with the electronic control assembly. The ultraviolet lamp is sleeved with a glass tube.

Preferably, the electronic control assembly further comprises a pump, a rectifier, and a main control board. The pump and the rectifier are electrically connected with the main control board. The main control board is connected with an external power source. The pump is connected with the water outlet seat.

Preferably, the pump is provided with a flow switch.

Preferably, the filter container includes a body, a casing, an upper cover, and a lower cover. The body is fitted on an outer surface of the second filtration layer. The upper cover and the lower cover are disposed at two ends of the casing, respectively. The upper cover covers the electronic control assembly, and the lower cover covers the water absorption base.

Preferably, a surface of the upper cover is provided with a handle.

Preferably, a first sealing ring is provided between the water absorption base and the body of the filter container.

Preferably, a second sealing ring is provided between the body of the filter container and the carbon filter cartridge of the filter element assembly.

Preferably, a third sealing ring is provided between the body of the filter container and the glass tube of the filter element assembly.

The beneficial effects of the present invention are described as below. The water absorption base is assembled to the filter element assembly. When in use, the water absorption base is directly immersed in the outdoor water source. First, the outdoor water is sucked by the water absorption base, and the water absorption base can filter out sediments, dirt, algae, insects and other impurities of the outdoor water for the first time. After that, the water entering the water absorption base is sucked into the filter container through the electronic control assembly. The filter element assembly in the filter container is used to filter the outdoor water for the second time and to sterilize, allowing a user to quickly get a large number of virus-free, bacteria-free, pollution-free safe drinking water in the wild, with high safety factor. This is an effective solution to the demand of drinking water for the outdoor sports enthusiasts.

### BRIEF DESCRIPTION OF THE DRAWINGS

FIG. 1 is a sectional view of a portable outdoor water purifier of the present invention; and

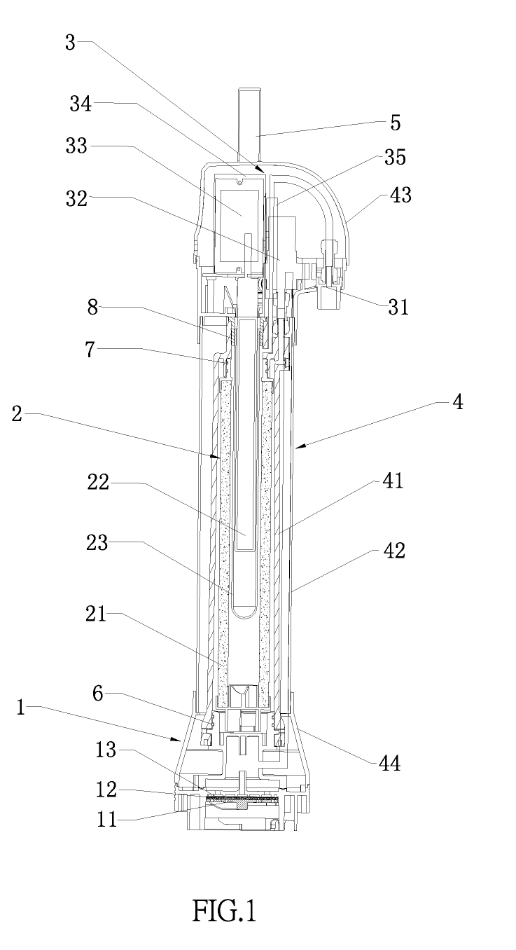

FIG. 2 is a perspective view of a portable outdoor water purifier of the present invention.

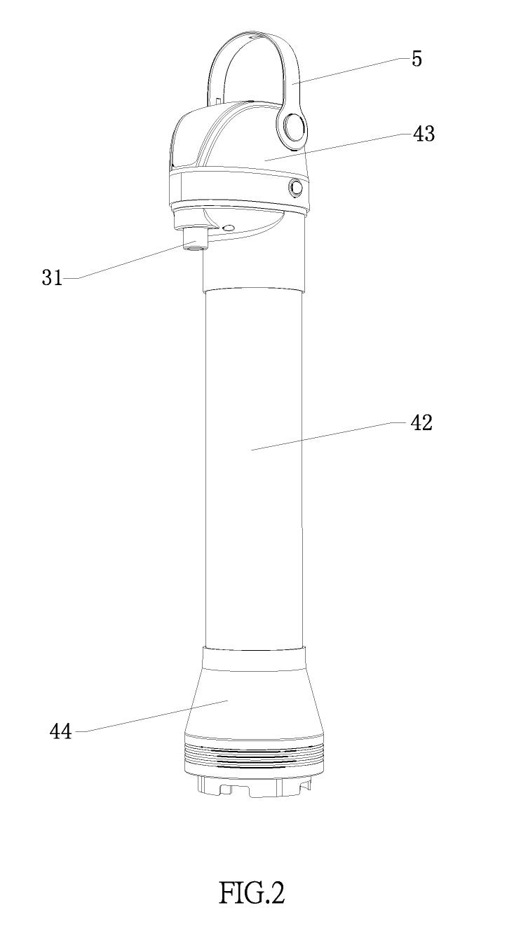

### DESCRIPTION OF THE PREFERRED EMBODIMENTS

In order to understand the present invention, embodiments of the present invention will now be described, by way of example only, with reference to the accompanying drawings.

A portable outdoor water purifier according to the present invention comprises a water absorption base 1, a filter element assembly 2, an electronic control assembly 3, and a filter container 4. The filter element assembly 2 is installed in the filter container 4. The water absorption base 1 is mounted to the lower end of the filter container 4. The water absorption base 1 is connected with the filter element assembly 2. The electronic control assembly 3 is mounted to the upper end of the filter container 4. The electronic control assembly 3 comprises a water outlet seat 31. Through the assembly of the water absorption base 1 and the filter element assembly 2, when in use, the water absorption base 1 is directly immersed in an outdoor water source. First, the outdoor water is sucked by the water absorption base 1, and the water absorption base 1 can filter out sediments, dirt, algae, insects and other impurities of the outdoor water for the first time. After that, the water entering the water absorption base 1 is sucked into the filter container 4 through the electronic control assembly 3. The filter element assembly 2 in the filter container 4 is used to filter the outdoor water for the second time and to perform sterilization, so that the user can quickly get a large number of virus-free, bacteria-free, pollution-free safe drinking water in the wild, with high safety factor. This is an effective solution to the demand of drinking water for the outdoor sports enthusiasts.

An inner chamber of the water-absorption base 1 is provided with a first filtration layer. The filter element assembly 2 is provided with a second filtration layer and a sterilization layer. A water outlet of the water absorption base 1 is communicated with a water absorption passage of the filter element assembly 2. An outlet of the water absorption passage of the filter element assembly 2 is communicated with the water outlet seat 31 of the electronic control assembly 3. Specifically, the present invention has the first filtration layer provided in the inner chamber of the water absorption base 1 and the second filtration layer and the sterilization layer of the filter element assembly 2 to remove the impurity from the outdoor water and to perform sterilization. The outdoor water is filtered layer by layer so as to quickly get safe and good drinking water.

In a preferred embodiment, the first filtration layer comprises a plastic mesh 11, a stainless steel mesh 12, and a nonwoven fabric mesh 13. The second filtration layer comprises a carbon filter cartridge 21. The sterilization layer comprises an ultraviolet lamp 22. The ultraviolet lamp 22 is located in an inner chamber of the carbon filter cartridge 21. The ultraviolet lamp 22 is electrically connected with the electronic control assembly 3. The ultraviolet lamp 22 is sleeved with a glass tube 23. In the present invention, the first filtration layer consists of three layers, namely, the plastic mesh 11, the stainless steel mesh 12 and the non-woven fabric mesh 13 which are gradually increased in density, to effectively remove large sediments, dirt, algae, insects and other impurities to reduce the turbidity of the outdoor water. Afterward, the carbon filter cartridge 21 of the second filtration layer is used to filter out toxic and harmful substances and further to adsorb bad taste in the water to achieve an acceptable taste. Furthermore, the second filtration layer is provided with the ultraviolet lamp 22 for sterilization. When the water passes through the carbon filter cartridge 21, the toxic and harmful substances are removed and the bad taste are adsorbed, and then the water is irradiated by the ultraviolet lamp 22 to sterilize viruses and bacteria, such as Escherichia coli, cholera bacteria and the like. The ultraviolet lamp 22 is placed in the inner chamber of the carbon filter cartridge 21, and the ultraviolet light can irradiate the water in all directions, so that the sterilization rate can be effectively improved. The sterilization rate of the present invention can reach more than 99.99% in compliance with drinking water standards for health and safety. The ultraviolet lamp 22 is sleeved with the glass tube 23, preventing the water from getting direct contact with the ultraviolet lamp 22 so as to prolong its service life.

Furthermore, the electronic control assembly 3 comprises a pump 32, a rectifier 33, and a main control board 34. The pump 32 and the rectifier 33 are electrically connected with the main control board 34. The main control board 34 is connected with an external power source. The pump 32 is connected with the water outlet seat 31. In the present invention, the pump 32 of the electronic control assembly 3 is capable of automatically absorbing water, and the rectifier 33 is capable of converting AC (alternating current) to DC (direct current), so that the present invention can be connected with either AC or DC, meeting the requirements of outdoor and domestic use.

Still further, the pump 32 is provided with a flow switch 35. The present invention has the flow switch 35 disposed at the pump 32 to control the water quantity, so that the user can select the output of the water volume according to the need. The present invention has the advantages of flexibility and convenience, and has better practicability.

The filter container 4 includes a body 41, a casing 42, an upper cover 43, and a lower cover 44. The body 41 is fitted on the outer surface of the second filtration layer. The upper cover 43 and the lower cover 44 are disposed at two ends of the casing 42, respectively. The upper cover 43 covers the electronic control assembly 3, and the lower cover 44 covers the water absorption base 1. In the present invention, the filter container 4 is composed of the body 41, the casing 42, the upper cover 43, and the lower cover 44. The appearance of the filter container 4 is pleasing to the eyes and able to cover the absorption base 1, the filter element assembly 2 and the electronic control assembly 3, effectively preventing the intrusion of foreign impurities.

The surface of the upper cover 43 is provided with a handle 5 which is convenient for the user to carry the water purifier.

Further, a first sealing ring 6 is provided between the water absorption base 1 and the body 41 of the filter container 4. A second sealing ring 7 is provided between the body 41 of the filter container 4 and the carbon filter cartridge 21 of the filter element assembly 2. A third sealing ring 8 is provided between the body 41 of the filter container 4 and the glass tube 23 of the filter element assembly 2. By providing the multiple sealing rings, the present invention can effectively prevent the outdoor water from overflowing to the body 41 or the casing 42 during the purifying process, thereby affecting the service life of the water purifier.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A portable outdoor water purifier, comprising a water absorption base, a filter element assembly, an electronic control assembly, and a filter container, the filter element assembly being installed in the filter container, the water absorption base being mounted to a lower end of the filter container, the water absorption base being connected with the filter element assembly, the electronic control assembly being mounted to an upper end of the filter container, the electronic control assembly comprising a water outlet seat.

2. The portable outdoor water purifier as claimed in claim 1, wherein an inner chamber of the water absorption base is provided with a first filtration layer, the filter element assembly is provided with a second filtration layer and a sterilization layer, a water outlet of the water absorption base is communicated with a water absorption passage of the filter element assembly, and an outlet of the water absorption passage of the filter element assembly is communicated with the water outlet seat of the electronic control assembly.

3. The portable outdoor water purifier as claimed in claim 2, wherein the first filtration layer comprises a plastic mesh, a stainless steel mesh, and a nonwoven fabric mesh, the second filtration layer comprises a carbon filter cartridge, the sterilization layer comprises an ultraviolet lamp, the ultraviolet lamp is located in an inner chamber of the carbon filter cartridge, the ultraviolet lamp is electrically connected with the electronic control assembly, and the ultraviolet lamp is sleeved with a glass tube.

4. The portable outdoor water purifier as claimed in claim 1, wherein the electronic control assembly further comprises a pump, a rectifier, and a main control board, the pump and the rectifier are electrically connected with the main control board, the main control board is connected with an external power source, and the pump is connected with the water outlet seat.

5. The portable outdoor water purifier as claimed in claim 4, wherein the pump is provided with a flow switch.

6. The portable outdoor water purifier as claimed in claim 3, wherein the filter container includes a body, a casing, an upper cover, and a lower cover, the body is fitted on an outer surface of the second filtration layer, the upper cover and the lower cover are disposed at two ends of the casing respectively, the upper cover covers the electronic control assembly, and the lower cover covers the water absorption base.

7. The portable outdoor water purifier as claimed in claim 6, wherein a surface of the upper cover is provided with a handle.

8. The portable outdoor water purifier as claimed in claim 6, wherein a first sealing ring is provided between the water absorption base and the body of the filter container.

9. The portable outdoor water purifier as claimed in claim 6, wherein a second sealing ring is provided between the body of the filter container and the carbon filter cartridge of the filter element assembly.

10. The portable outdoor water purifier as claimed in claim 6, wherein a third sealing ring is provided between a body of the filter container and the glass tube.
